(19) United States
(12) Patent Application Publication
(10) Pub. No.: US 2007/0011353 A1
(43) Pub. Date: Jan. 11, 2007

(54) System, method, and program product for extracting information from an identifier

(75) Inventors: Scott D. Hicks, Underhill Center, VT (US); James A. Martin JR., Endicott, NY (US); Douglas G. Murray, Johnson City, NY (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/174,991

(22) Filed: Jul. 5, 2005

(51) Int. Cl. G06F 15/16

(52) U.S. Cl. 709/245

(57) ABSTRACT

The present invention provides a system, method and program product for automatically extracting information (e.g., address information) from an identifier (e.g., a network port identifier). Specifically, under the present invention, a set of identifier parsing rules are applied to an identifier to determine sets of characters in the identifier that represent distinct pieces of information. Thereafter, a set of translation rules are applied to the sets of characters to translate the sets of characters into the distinct pieces of information. Once translated, the pieces of information can be electronically stored for later use. In addition, the present invention provides views of the sets of rules so that they can be observed and/or edited.

### BACKGROUND OF THE INVENTION

1. Field of the Invention

The present invention generally relates to electronic information extraction. Specifically, the present invention relates to a system, method, and program product for extracting information (e.g., address information) from an identifier (e.g., a network port identifier).

2. Related Art

As Information Technology (IT) continues to advance, many organizations are faced with the task of migrating their existing computer infrastructures, telephone systems and the like to newer technology. For example, an organization might wish to migrate its networking functions from token ring to Ethernet. Similarly, an organization might wish to migrate its telephone service from a landline-based service to a voice-over-IP service.

One aspect of performing IT migrations is being able to determine address information from various other pieces of information/identifiers. One example of this is a network port identifier. Specifically, when working with network ports, it is often necessary to be able to look at the network port identifier and extract the information encoded therein such as a corresponding building, floor, office, network closet and network rack, etc. Current methodologies require such extraction to be performed manually by individuals who know the encoding format. Unfortunately, the encoding standards can differ between locations within an enterprise, or between different enterprises. That is, there currently does not exist a utility that can automatically extract such information, and then electronically store the information for later use.

In view of the foregoing, there exists a need for a system, method, and program product for extracting information from an identifier. Specifically, a need exists for a utility that can automatically extract address information from an identifier such as a network port identifier.

### SUMMARY OF THE INVENTION

In general, the present invention provides a system, method, and program product for automatically extracting information (e.g., address information) from an identifier (e.g., a network port identifier). Specifically, under the present invention, a set of identifier parsing rules are applied to an identifier to determine sets of characters in the identifier that represent distinct pieces of information. Thereafter, a set of translation rules are applied to the sets of characters to translate the sets of characters into the distinct pieces of information. Once translated, the pieces of information can be electronically stored for later use. In addition, the present invention provides views of the sets of rules so that they can be observed, modified, added to, deleted, etc.

A first aspect of the present invention provides a system for extracting information from an identifier, comprising: a system for applying a set of identifier parsing rules to the identifier to determine sets of characters of the identifier that represent the information; and a system for applying a set of translation rules to the sets of characters to translate the sets of characters into the information.

A second aspect of the present invention provides a computer-implemented method for information from an identifier, comprising: applying a set of identifier parsing rules to the identifier to determine sets of characters of the identifier that represent the information; and applying a set of translation rules to the sets of characters to translate the sets of characters into the information.

A third aspect of the present invention provides a computer-implemented method for address information from a network port identifier, comprising: applying a set of identifier parsing rules to the network port identifier to determine sets of characters of the network port identifier that represent distinct pieces of the address information; and applying a set of translation rules to the sets of characters to translate the sets of characters into the distinct pieces of the address information.

A fourth aspect of the present invention provides a program product stored on a computer readable medium for extracting address information from a network port identifier, the computer readable medium comprising program code for performing the following steps: applying a set of identifier parsing rules to the network port identifier to determine sets of characters of the network port identifier that represent distinct pieces of the address information; and applying a set of translation rules to the sets of characters to translate the sets of characters into the distinct pieces of the address information.

A fifth aspect of the present invention provides a method for deploying an application for extracting address information from a network port identifier, comprising: providing a computer infrastructure being operable to: apply a set of identifier parsing rules to the network port identifier to determine sets of characters of the network port identifier that represent distinct pieces of the address information; and apply a set of translation rules to the sets of characters to translate the sets of characters into the distinct pieces of the address information.

A sixth aspect of the present invention provides computer software embodied in a propagated signal for extracting address information from a network port identifier, the computer software comprising instructions for performing the following functions: apply a set of identifier parsing rules to the network port identifier to determine sets of characters of the network port identifier that represent distinct pieces of the address information; and apply a set of translation rules to the sets of characters to translate the sets of characters into the distinct pieces of the address information.

Therefore, the present invention provides a system, method and program product for extracting information from an identifier.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for extracting information from an identifier according to the present invention.

FIG. 2 shows an illustrative view of a set of identifier parsing rules according to the present invention.

FIG. 3 shows an illustrative view of a set of translation parsing rules according to the present invention.

FIG. 4 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the present invention provides a system, method and program product for automatically extracting information (e.g., address information) from an identifier (e.g., a network port identifier). Specifically, under the present invention, a set of identifier parsing rules are applied to an identifier to determine sets of characters in the identifier that represent distinct pieces of information. Thereafter, a set of translation rules are applied to the sets of characters to translate the sets of characters into the distinct pieces of information. Once translated, the pieces of information can be electronically stored for later use. In addition, the present invention provides views of the sets of rules so that they can be observed, modified, added to, deleted, etc.

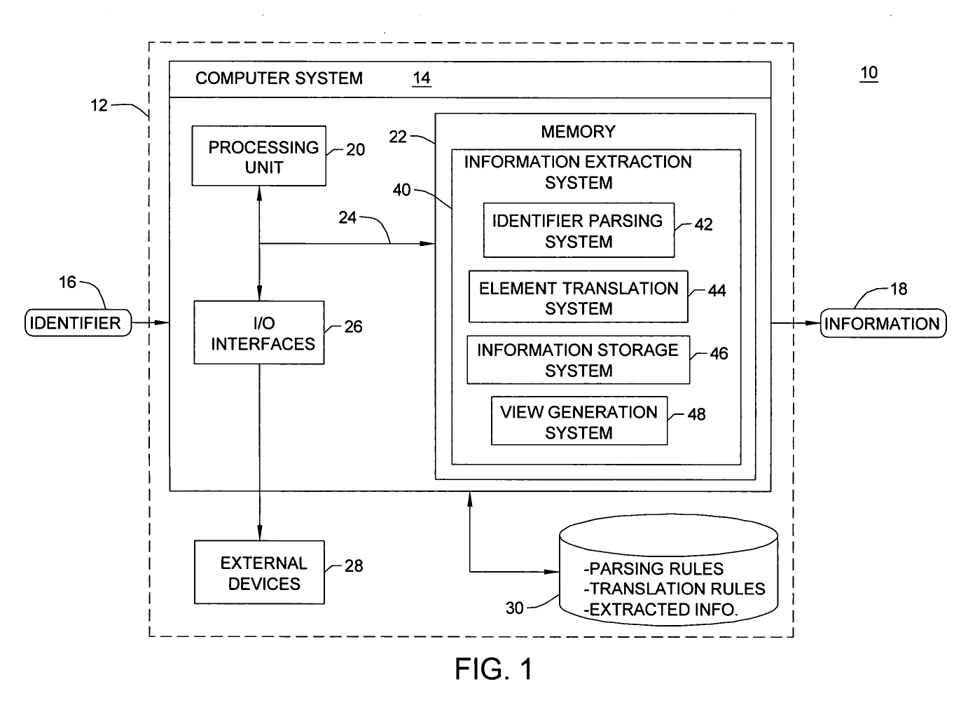

Referring now to FIG. 1, a system 10 for automatically and electronically extracting information 18 from an identifier 16 according to the present invention is shown. It should be understood in advance that in a typical embodiment, identifier 16 is a network port identifier and information 18 is address information. However, this need not be the case. Rather, system 10 could be used to automatically and electronically extract any type of information from any type of computer-based identifier. In any event, as shown, system 10 includes a computer system 14 deployed within a computer infrastructure 12. This is intended to demonstrate that the present invention could be implemented within a network environment (e.g., the Internet, a wide area network (WAN), a local area network (LAN), a virtual private network (VPN), etc., or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, it should be understood that come or all of the components of system 10 could be deployed, managed, serviced, etc. by a service provider who offers to extract information 18 from identifiers 16 for customers.

In any event, computer system 14 is shown including a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as information extraction system 40, which is stored in memory 22 and/or storage system 30. While executing computer program code, processing unit 20 can read and/or write data, to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention such as identifier parsing rules, translation rules, extracted address information, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is information extraction system 40, which includes identifier parsing system 42, element translation system 44, information storage system 46, and view generation system 48. It should be understood that any of these systems could be implemented as software agents. In an illustrative embodiment, assume that extraction of address information 18 from a network port identifier 16 is desired. As known in the art, network port identifiers can include a series of values, (numbers and/or letters) strung together. When viewed as such, it is extremely difficult to extract any meaningful information therefrom without applying different translation schemes, which prior to the present invention has been a manual and laborious process. In this example, assume that identifier 16 resembles the following: 96501D021090301.

Before information 18 can be extracted from identifier 16, it must first be determined what sets of characters of identifier 16 represent distinct or meaningful pieces of information. To this extent, under the present invention, identifier parsing system 42 will apply a set of identifier parsing rules to identifier 16 to (automatically) determine the sets of characters of identifier 16. It should be appreciated that under the present invention, the term “set” is intended to mean one or more. As such, a set of characters as used herein can include one or more characters of identifier 16. In the event that the set includes multiple characters of identifier 16, such multiple characters may or may not be contiguous (i.e., next to one another) in identifier 16. Regardless, for the example identifier 16 set forth above, assume that identifier parsing system 42 will apply the following set of identifier parsing rule(s):

Character set 1=characters 1-3;

Character set 2=characters 4-6;

Character set 3=characters 7-9;

Character set 4=characters 10-11;

Character set 5=characters 12-13; and

Character set 6=characters 14-15.

Based on these rule(s), it can be seen that six sets of characters have been determined from identifier 16 to represent distinct pieces of information 18. After these sets of characters have been determined, element translation system 44 will apply a set of translation rules to the sets of characters to (automatically) translate the sets of characters into their respective pieces of information 18. For example, assume that element translation system 44 will apply the following set of translation rule(s):

Characters 1-3 translated to yield the building in which the wallport closet resides=965;

Characters 4-5 translated to yield the floor=01;

Characters 6-9 translated to yield the closet room number=D021;

Building/floor/closet room number translated to closet name, 96501D021=“Building 965 North LAN Closet” per a lookup table (e.g., in storage unit 30) containing all closet room to name mappings;

Characters 10-11 translated to yield the tower number in the closet=09;

Characters 12-13 translated to yield the rack number in the tower=03; and

Characters 14-15 translated to yield the row number in the rack=01.

As can be seen, the application of the set of identifier parsing rules and subsequent application of the set of translation rules results in an extraction of meaningful information 18. In this example, the exact network closet, tower, rack, and row are (automatically) extracted from identifier 16. These items represent information 18 that can be outputted (e.g., to an administrator or the like) as shown in FIG. 1, and/or electronically stored (e.g., in a file, database, record, etc.) by information storage system 46.

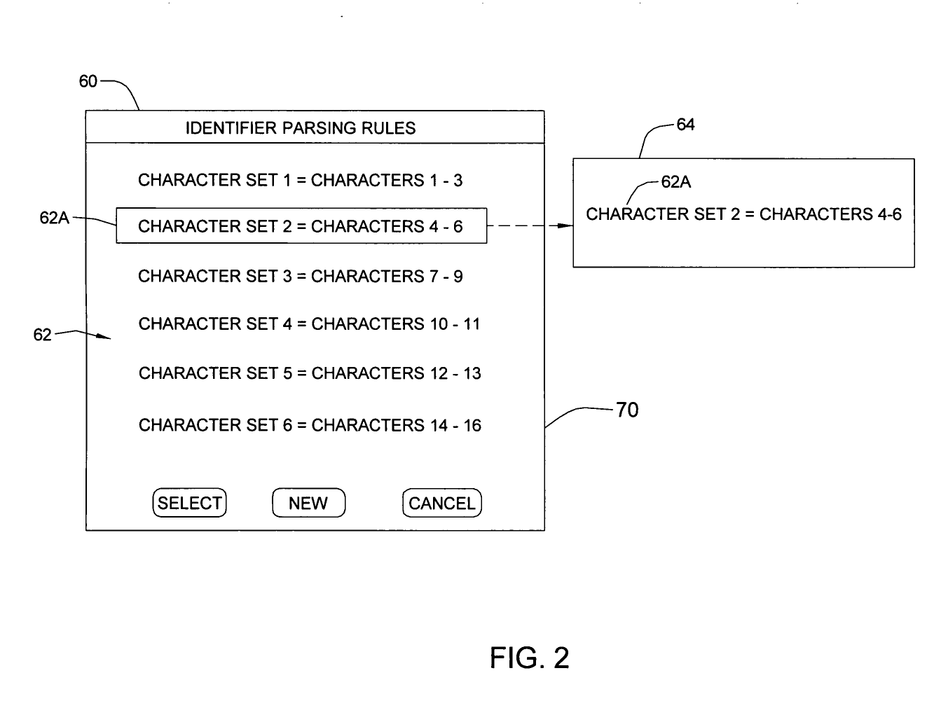

As further shown in FIG. 1, information extraction system 40 further includes view generation system 48, which generates views of the rules referred to herein. Such views allow for the viewing/observation, creation, modification, deletion, etc. of identifier parsing rules and translation rules. Referring to FIG. 2, an illustrative view 60 of the identifier parsing rules 62 shown above is depicted. As further shown, view 60 allows one or more identifier parsing rules 62 (e.g., parsing rule 62A) to be selected. Selection can occur in any known manner such using an input device (e.g., mouse, keyboard, etc.) and the “Select” button. Regardless, once selected, identifier parsing rule 62A can be displayed in a separate document 64 for individual viewing, modification and/or deletion. If the “New” button was selected, document 64 could be blank so that a new identifier parsing rule could be provided.

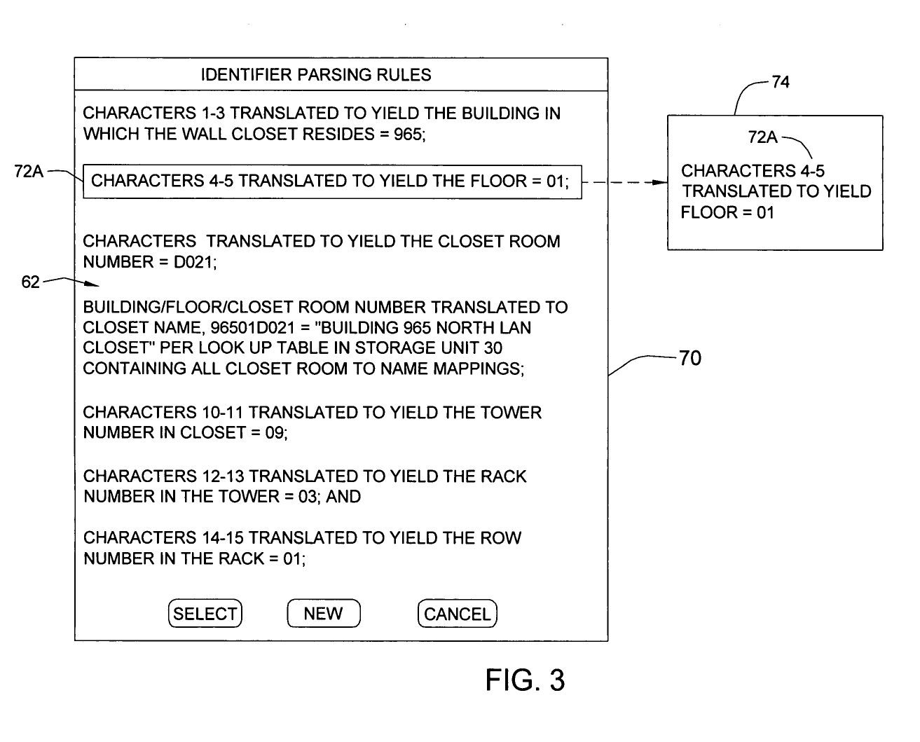

Referring now to FIG. 3, a similar view 70 is shown for the translation rules 72 as generated by view generation system 48 (FIG. 1). Similar to view 60 of FIG. 2, translation rules 72 can be selected using an input device and the “Select” button. Upon such selection, a separate document 74 for the selected translation rule 72A will be generated and displayed so that the selected translation rule 72A can be viewed, modified, and/or deleted. Similar to FIG. 2, if the “New” button was selected in FIG. 3, document 74 would be blank so that a new identifier parsing rule could be provided.

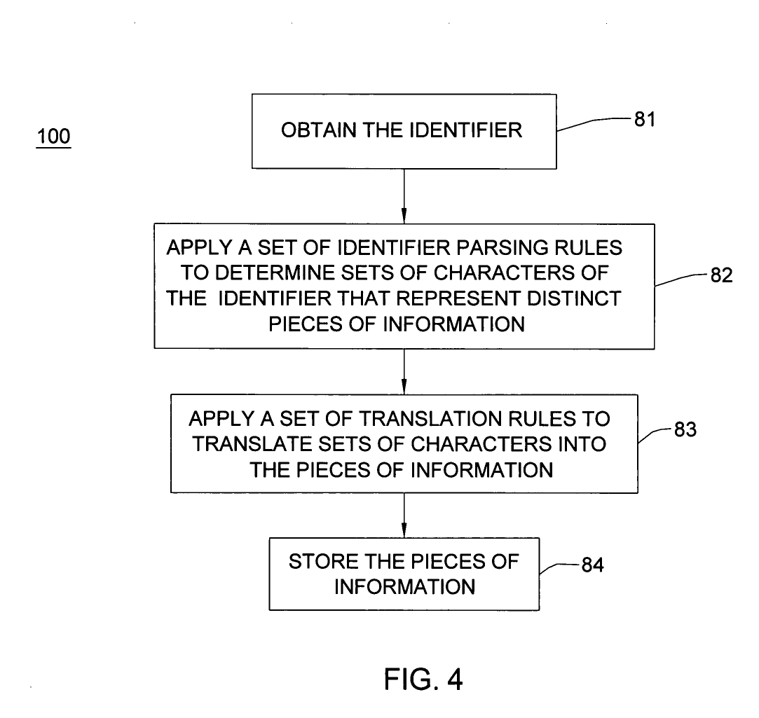

Referring now to FIG. 4, a method flow diagram 100 according to the present invention is shown. As depicted, first step S1 is to obtain an identifier. Under the present invention, the identifier can be obtained in any number of ways. For example, it can be manually input, it can be retrieved from storage (e.g., storage unit 30), etc. Second step S2 is to apply a set of identifier parsing rules to the identifier to determine sets of characters of the identifier that represent distinct pieces of information. Third step S3 is to apply a set of translation rules to the sets of characters to translate the sets of characters into the pieces information. Fourth step S4 is to store the extracted pieces of information.

While shown and described herein as a method and system for extracting information from an identifier, it is understood that the invention further provides various alternative embodiments. For example, in one embodiment, the invention provides a computer-readable medium that includes computer program code to enable a computer infrastructure to extract information from an identifier. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to extract information from an identifier. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method for extracting information from an identifier. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A system for extracting information from an identifier, comprising:
a system for applying a set of identifier parsing rules to the identifier to determine sets of characters of the identifier that represent the information; and
a system for applying a set of translation rules to the sets of characters to translate the sets of characters into the information.

2. The system of claim 1, wherein the information comprises a network port identifier.

3. The system of claim 1, further comprising a system for generating a view of the set of identifier parsing rules.

4. The system of claim 1, further comprising a system for generating a view of the set of translation rules.

5. The system of claim 1, wherein the system for applying the set of identifier parsing rules and the system for applying a set of translation rules comprise software agents.

6. The system of claim 1, wherein each of the sets of characters represent distinct pieces of the information.

7. The system of claim 1, further comprising a system for obtaining the identifier.

8. The system of claim 1, further comprising a system for storing the information.

9. A computer-implemented method for information from an identifier, comprising:
applying a set of identifier parsing rules to the identifier to determine sets of characters of the identifier that represent the information; and
applying a set of translation rules to the sets of characters to translate the sets of characters into the information.

10. The method of claim 9, wherein the information comprises a network port identifier.

11. The method of claim 9, further comprising generating a view of the set of identifier parsing rules.

12. The method of claim 9, further comprising generating a view of the set of translation rules.

13. The method of claim 9, wherein each of the sets of characters represent distinct pieces of the information.

14. The method of claim 9, further comprising:
obtaining the identifier; and
storing the information.

15. A computer-implemented method for address information from a network port identifier, comprising:
applying a set of identifier parsing rules to the network port identifier to determine sets of characters of the network port identifier that represent distinct pieces of the address information; and
applying a set of translation rules to the sets of characters to translate the sets of characters into the distinct pieces of the address information.

16. A program product stored on a computer readable medium for extracting address information from a network port identifier, the computer readable medium comprising program code for performing the following steps:
applying a set of identifier parsing rules to the network port identifier to determine sets of characters of the network port identifier that represent distinct pieces of the address information; and
applying a set of translation rules to the sets of characters to translate the sets of characters into the distinct pieces of the address information.

17. The program product of claim 16, wherein the computer readable medium further comprises program code for performing the following step: generating a view of the set of identifier parsing rules.

18. The program product of claim 16, wherein the computer readable medium further comprises program code for performing the following step: generating a view of the set of translation rules.

19. The program product of claim 16, wherein each of the sets of characters represent distinct pieces of the address information.

20. The program product of claim 16, wherein the computer readable medium further comprises program code for performing the following steps:
obtaining the network port identifier; and
storing the distinct pieces of the address information.

21. A method for deploying an application for extracting address information from a network port identifier, comprising:
providing a computer infrastructure being operable to:
apply a set of identifier parsing rules to the network port identifier to determine sets of characters of the network port identifier that represent distinct pieces of the address information; and
apply a set of translation rules to the sets of characters to translate the sets of characters into the distinct pieces of the address information.

22. The method of claim 21, wherein the computer infrastructure is further operable to:
generate a view of the set of identifier parsing rules;
generate a view of the set of translation rules;
obtain the network port identifier; and
store the distinct pieces of the address information.
